(19) United States
(12) Patent Application Publication
(10) Pub. No.: US 2017/0373515 A1
(43) Pub. Date: Dec. 28, 2017

(54) CORDLESS HAIR TOOLS

(71) Applicant: Elizabeth Friday-Skoda, Hackettstown, NJ (US)

(72) Inventor: Elizabeth Friday-Skoda, Hackettstown, NJ (US)

(21) Appl. No.: 15/636,580

(22) Filed: Jun. 28, 2017

Related U.S. Application Data
(60) Provisional application No. 62/355,842, filed on Jun. 28, 2016.

(51) Int. Cl. H02J 7/00; B26B 19/38; A45D 1/04; A45D 2/00; A45D 20/12; A45D 1/00

(52) U.S. Cl. CPC H02J 7/0027; A45D 2/001; A45D 20/12; B26B 19/3873; H02J 7/0045; A45D 1/04; H02J 7/0021; A45D 2001/002; A45D 2001/045; A45D 2001/004

(57) ABSTRACT

A product line of battery-powered, cordless blow-dryers, curling irons, flat-irons, and hair-clippers to eliminate the frustration, limitations, and accidental mishaps associated with easily tangled power cords, while providing premium-quality styling tools featuring removable batteries which are easily charged in the provided charging base to provide the utmost in convenience to both professional stylist's and barbers, and consumer households.

### CROSS-REFERENCE TO RELATED APPLICATION

The present application is related to and claims priority from prior provisional application Ser. No. 62/355,842, filed Jun. 28, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of hair tool devices and more specifically relates to a hair tools assembly structured and arranged to be battery-powered and cordless thereby eliminating the frustration, limitations, and accidental mishaps associated with easily tangled power cords, while providing premium-quality styling tools featuring removable batteries which are easily charged in the provided charging base to provide the utmost in convenience to both professional stylist's and barbers, and consumer households.

### 2. Description of the Related Art

Professional stylists and barbers, and also by millions of householders use hair styling tools to blow-dry, cut and style their own hair. Unfortunately, these tools comprising bulky cords and require an outlet nearby to provide power. Therefore, a need exists for Cordless Hair Tools to revolutionize the work of stylists and barbers, as well as the daily activities of household consumers who blow-dry, style, and cut their own and other's hair.

Various attempts have been made to solve problems found in cordless hair tools art. Among these are found in: U.S. Pat. No. 7,380,347 to Carrie R. Coats et al; U.S. Pat. No. 8,146,264 to Robert Stefano et al; and U.S. Publication No. 2013/0056017 to Dennis Rigsby. This prior art is representative of battery-powered cordless hair tools. None of the above inventions and patents, taken either singly or in combination, is seen to describe the invention as claimed.

Ideally, a hair tools assembly should be user-friendly and safe in-use and, yet should operate reliably and be manufactured at a modest expense. Thus, a need exists for a hair tools assembly structured and arranged to be battery-powered and cordless thereby eliminating the frustration, limitations, and accidental mishaps associated with easily tangled power cords, while providing premium-quality styling tools featuring removable batteries which are easily charged in the provided charging base to provide the utmost in convenience to both professional stylist's and barbers, and consumer households.

### BRIEF SUMMARY OF THE INVENTION

In view of the foregoing disadvantages inherent in the known hair tool device art, the present invention provides a hair tools assembly (Entitled Cordless Hair Tools). The general purpose of the present invention, which will be described subsequently in greater detail is to provide a hair tools assembly structured and arranged to be battery-powered and cordless thereby eliminating the frustration, limitations, and accidental mishaps associated with easily tangled power cords, while providing premium-quality styling tools featuring removable batteries which are easily charged in the provided charging base to provide the utmost in convenience to both professional stylist's and barbers, and consumer households.

A hair tools assembly is disclosed herein in a preferred embodiment comprising a charging body; a plurality of battery members; and at least one hair tool. The charging body includes a plurality of charging stations; and a charging cord. The plurality of charging stations includes a socket portion adapted to transfer electrical energy between an external power supply and a hair tool. The charging cord extends outwardly therefrom and is adapted to releasable and electrically connect between an external power source and each of the plurality of charging stations.

The plurality of battery members are each adapted to respectively fit and be removably placed within each respective said charging station, such that they can be charged and recharged therein via said external power supply.

The at least one hair tool includes a handle portion and a tool portion. The handle portion includes a socket portion extending into an interior volume thereof. The socket portion is adapted to removably receive one of said plurality of battery members therein to thereby energize the hair tool. The tool portion is connected to the handle portion. The at least one hair tool is adapted to be used upon hair.

The present invention holds significant improvements and serves as a hair tools assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, hair tools assembly (Entitled Cordless Hair Tools), constructed and operative according to the teachings of the present invention.

FIG. 1 shows a perspective view illustrating a hair tools assembly in an in-use condition according to an embodiment of the present invention.

FIG. 2 is a perspective view illustrating a blow-dryer hair tool of the hair tools assembly according to an embodiment of the present invention of FIG. 1.

FIG. 3 is a perspective view illustrating a charging body of the hair tools assembly according to an embodiment of the present invention of FIG. 1.

FIG. 4 is a perspective view illustrating a plurality of battery members of the hair tools assembly according to an embodiment of the present invention of FIG. 1.

FIG. 5 is a perspective view illustrating the plurality of hair tool including a blow-dryer, a curling iron, a flat-iron, a trimmer, and a clipper of the hair tools assembly according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to hair tool device and more specifically relates to a hair tools assembly (Entitled Cordless Hair Tools). The general purpose of the present invention, which will be described subsequently in greater detail is to provide a hair tools assembly structured and arranged to be battery-powered and cordless thereby eliminating the frustration, limitations, and accidental mishaps associated with easily tangled power cords, while providing premium-quality styling tools featuring removable batteries which are easily charged in the provided charging base to provide the utmost in convenience to both professional stylist's and barbers, and consumer households

Generally speaking, the Cordless Hair Tools comprising a novel product offering consumers a practical solution to the aforementioned challenges. As the name implies, the Cordless Hair Tools comprises a specially designed line of blow-dryers, curling irons, flat-irons, trimmers, and clippers. The Cordless Hair Tools, in all respects other than the power cords, would be premium-quality styling tools; and the Tools might be produced in two basic variations: 1) professional, heavy-duty versions for working stylists and barbers, who have multiple clients throughout the day; and 2) in slightly less-robust versions for household consumer use, where the individual tools are used less intensively. Each of the Cordless Hair Tools would feature a removable snap-locking rechargeable battery compartment in the handle, with these batteries easily recharged in the provided charging base. Each tool would also feature a red/green LED to indicate battery life: the green LED indicating a full or sufficient charge, the red LED indicating a need to recharge through the charging base or cradle.

With the Cordless Hair Tools, there would be no power cords to twist and tangle, catch and intertwine—and thus no need, prior to and after using them, to untangle the cords, or pick up the objects the cords have knocked onto the floor. By freeing the user of annoying and troublesome power cords, the Cordless Hair Tools—whether blow-dryers, curling or flat-irons, or trimmers and clippers—would make drying, styling, and cutting hair a pleasure rather than (as the cords so often make it) a hassle.

Recharging quickly when not in use, the Cordless Hair Tools would be equally suitable for professional and at home use; and these cordless styling tools—clever in conception, thoughtful in design, and conceived to meet a real need shared by millions of professional aesthetic workers and household consumers alike—should find a wide and enthusiastic market reception

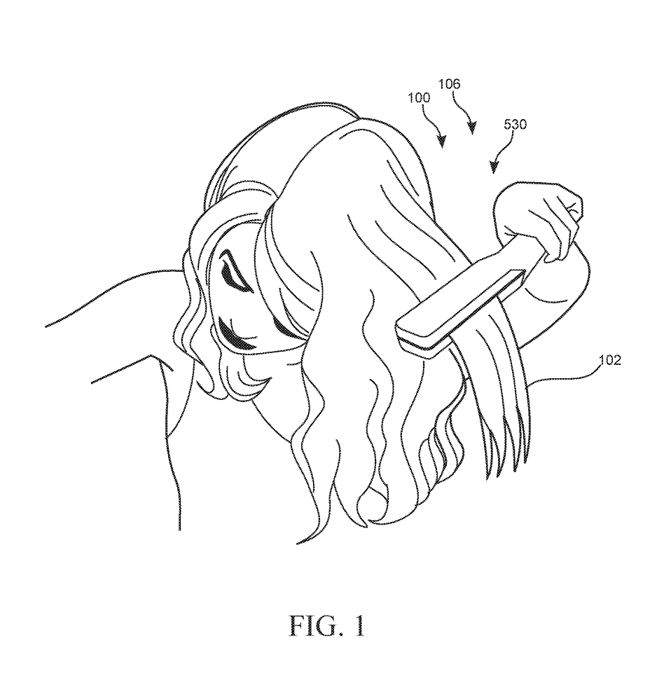

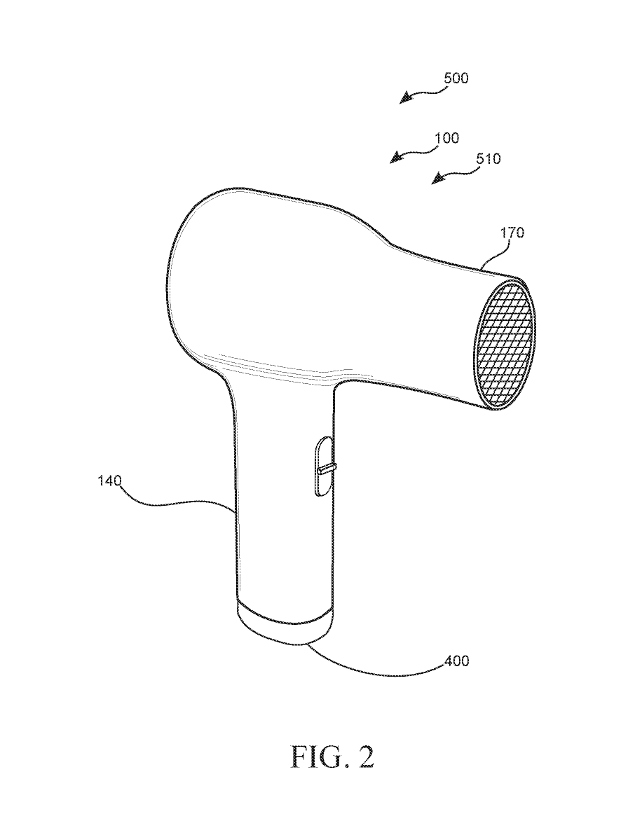

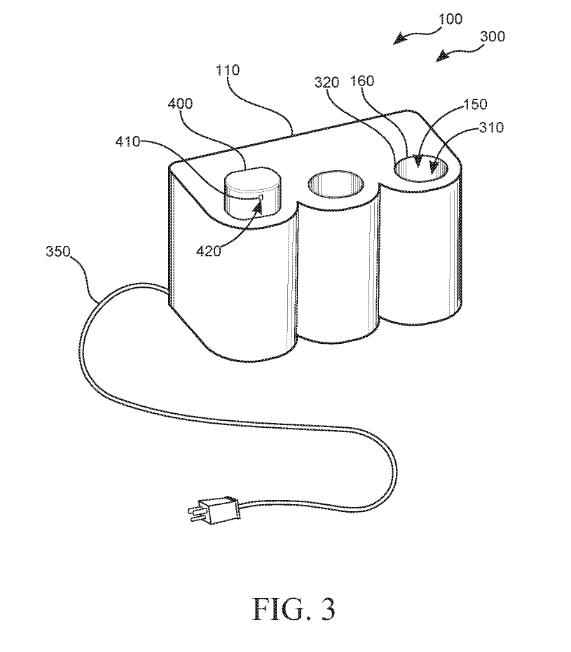

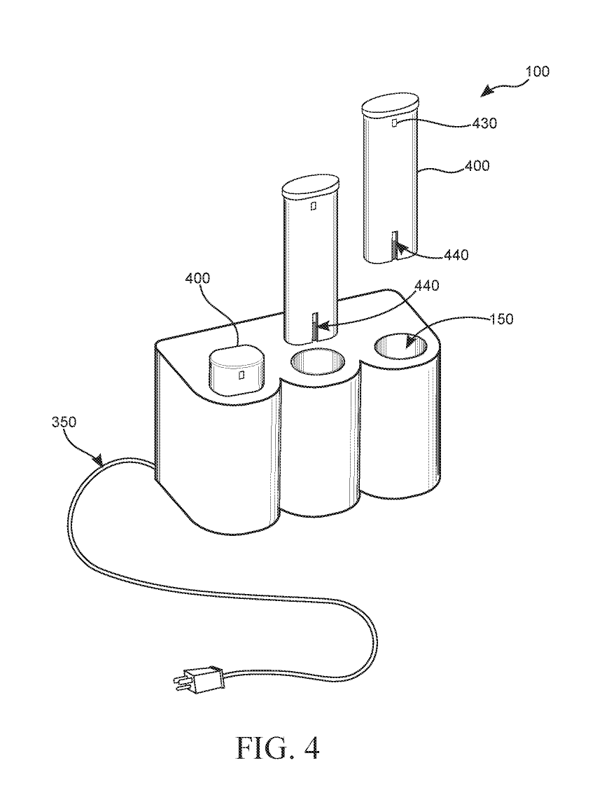

Referring now to FIGS. 1-5, showing perspective views illustrating hair tools assembly 100 according to an embodiment of the present invention of FIG.

Hair tools assembly 100 is disclosed herein in a preferred embodiment comprising charging body 110; plurality of battery members 400; and at least one hair tool 500. Charging body 110 includes plurality of charging stations 300; and charging cord 350. Charging body 110 is formed from a material chosen from a list of materials consisting of plastic and ceramic. There are preferably three charging stations 300 and three battery members 400.

At least one hair tool 130 includes handle portion 140 and tool portion 170. Handle portion 140 includes socket portion 150 extending into an interior volume thereof. Handle portion 140 of at least one hair tool 130 is formed from a material chosen from a list of materials consisting of plastic and ceramic. Upon reading this specification, it should be appreciated that, under appropriate circumstances, considering such issues as user preferences, design preference, structural requirements, marketing preferences, cost, available materials, technological advances, etc., other material arrangements may be sufficient.

Socket portion 150 is adapted to removably receive one of plurality of battery members 400 therein to thereby energize hair tool 130. Tool portion 170 is connected to handle portion 140. Each hair tool socket portion 150 includes ridge portion 160 along a length thereof adapted to fit within slot 440 of each of plurality of battery members 400 to thereby guide each battery member 400 into and out of each of hair tool socket portion 150.

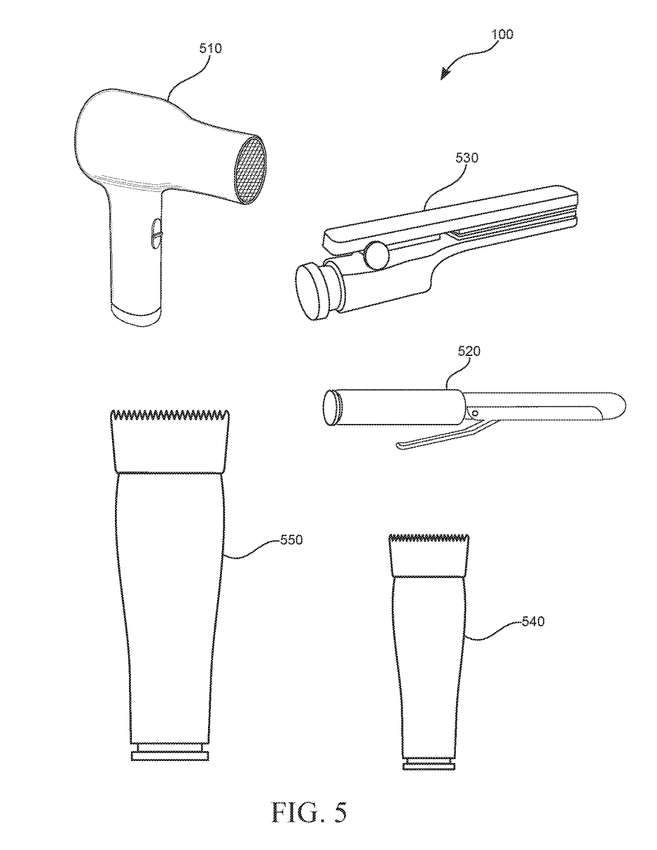

As shown in FIG. 5 there are five hair tools 500 including blow-dryer 510, curling iron 520, flat-iron 530, trimmer 540, and clipper 550. At least one hair tool 500 is adapted to be used upon hair 102 as shown in in-use condition 106 of FIG. 1. At least one hair tool 500 is chosen from a group of tool portions 170 consisting of blow-dryer 510, curling iron 520, flat-iron 530, trimmer 540, and clipper 550 as shown in FIG. 5.

Plurality of battery members 400 are each adapted to respectively fit and be removably placed within each respective charging station 300, such that they can be charged and recharged therein via an external power supply. Plurality of battery members 400 are chosen from a list of battery members consisting of nickel cadmium, nickel metal-hydride, lead acid, lithium ion, and lithium polymer. Plurality of battery members 400 includes a light emitting diode 410 thereon adapted to change between green color 420 indicating a sufficient electric charge and red color 430 indicating an insufficient electric charge. Each of plurality of battery members 400 includes slot 400 along a length thereof adapted to guide battery member 400 into and out of its respective charging station 300 and hair tool socket portion.

Plurality of charging stations 300 includes socket portion 310 adapted to transfer electrical energy between an external power supply and hair tool 170. Charging cord 350 extends outwardly therefrom and is adapted to releasable and electrically connect between an external power source and each plurality of charging stations 300. Each of plurality of charging stations 300 includes ridge portion 320 along a length thereof adapted to fit within slot 440 of each of plurality of battery members 400 to thereby guide each battery member 400 into and out of each of plurality of charging stations 300.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hair tools assembly comprising:
a charging body including:
a plurality of charging stations;
wherein each said plurality of charging stations includes a socket portion adapted to transfer electrical energy between an external power supply and a hair tool; and
a charging cord;
wherein said charging cord extends outwardly therefrom and is adapted to releasable and electrically connect between an external power source and each said plurality of charging stations;
a plurality of battery members;
wherein said plurality of battery members are each adapted to respectively fit and be removably placed within each respective said charging station, such that they can be charged and recharged therein via said external power supply;
at least one hair tool including:
a handle portion;
wherein said handle portion includes a socket portion extending into an interior volume thereof; and
wherein said socket portion is adapted to removably receive one of said plurality of battery members therein to thereby energize said hair tool;
a tool portion;
wherein said tool portion is connected to said handle portion;
wherein said at least one hair tool is adapted to be used upon hair.

2. The hair tools assembly of claim 1, wherein said at least one hair tool is chosen from a group of tool portions consisting of a blow-dryer, a curling iron, a flat-iron, a trimmer, and a clipper.

3. The hair tools assembly of claim 1, wherein each said plurality of battery members includes a light emitting diode thereon adapted to change between a green color indicating a sufficient electric charge and a red color indicating an insufficient electric charge.

4. The hair tools assembly of claim 1, wherein each of said plurality of battery members includes a slot along a length thereof adapted to guide said battery member into and out of its respective charging station and hair tool socket portion.

5. The hair tools assembly of claim 4, wherein each of said plurality of charging stations includes a ridge portion along a length thereof adapted to fit within said slot of each of said plurality of battery members to thereby guide each said battery member into and out of each of said plurality of charging stations.

6. The hair tools assembly of claim 5, wherein each said hair tool socket portion includes a ridge portion along a length thereof adapted to fit within said slot of each of said plurality of battery members to thereby guide each said battery member into and out of each of hair tool socket portion.

7. The hair tools assembly of claim 1, wherein said plurality of battery members are chosen from a list of battery members consisting of nickel cadmium, nickel metal-hydride, lead acid, lithium ion, and lithium polymer.

8. The hair tools assembly of claim 1, wherein said charging body is formed from a material chosen from a list of materials consisting of plastic and ceramic.

9. The hair tools assembly of claim 8, wherein said handle portion of said at least one hair tool is formed from a material chosen from a list of materials consisting of plastic and ceramic.

10. The hair tools assembly of claim 1, wherein there are three charging stations and three battery members.

11. The hair tools assembly of claim 1, wherein there are five hair tools including a blow-dryer, a curling iron, a flat-iron, a trimmer, and a clipper.
